(19) United States
(12) Patent Application Publication
(10) Pub. No.: US 2006/0032045 A1
(43) Pub. Date: Feb. 16, 2006

(54) Method for the production of devices for storing electric power based on rechargeable lithium polymer cells

(75) Inventors: Herbert Naarmann, Frankenthal (DE); Franz Josef Kruger, Eppstein (DE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: GAIA Akkumulatorenwerke GMBH, Nordhausen (DE)

(21) Appl. No.: 10/520,972

(22) PCT Filed: Jul. 10, 2003
(86) PCT No.: PCT/EP03/07517

§ 371 Date: Jul. 19, 2005

(30) Foreign Application Priority Data
Jul. 11, 2002 (DE) 102 31 319.9

(51) Int. Cl. H01M 10/04; H01M 4/48; H01M 4/62

(52) U.S. Cl. 29/623.3; 429/231.1; 429/217

(57) ABSTRACT

The present invention includes a process for the manufacture of a storage device for electrical energy. The process includes degassing an anode mass and a cathode mass. The anode mass includes a lithium intercalatable carbon in a mixture with one or more of an organic solvent, a supporting electrolyte, a polymer binder and a supporting electrolyte additive. The cathode mass includes a lithium intercalatable heavy metal oxide in a mixture with one or more of an organic solvent, a supporting electrolyte a polymer binder and a supporting electrolyte additive. The cathode mass and the anode mass are applied to current conductors. A separator is disposed between the anode mass and the cathode mass to form a composite. The composite is laminated to form the storage device.

Storage devices for electrical energy consist of a composite system of anode, cathode and separator.

In lithium polymer cells, the storage system consists of Li intercalatable carbon as anode, an Li intercalatable heavy metal oxide as cathode and a separator as separating intermediate layer.

The composite obtained is then processed into multiple layers and made into prismatic and/or wound cells. After incorporation into a housing and poling, a lithium polymer battery is obtained which, after forming, is ready for use; with a voltage of approximately 4 volts and cycle cells of >300.

Details regarding the manufacture and the system are known from the literature and can be found in “Handbook of Battery Materials” edit. I. O. Besenhard, Verlag VCH, Weinheim, 1999, (1). Special manufacturing processes such as e.g. the so-called Bellcore process are described in “Lithium Ion Batteries” edit M. Wakihara and O. Yamamoto, Verlag VCH, Weinheim 1998, page 235 and FIG. 10.9 (2).

In principle, different processes are used for the manufacture of the lithium polymer battery. Firstly, the coating process in which the polymer binder(s) necessary for the cathode and/or anode mass is dissolved (e.g. approximately 5-10% fluoroelastomers homo or copolymers in e.g. N-methyl pyrrolidone (NMP) and to this polymer solution, cathode-specific or anode-specific additives such as Li intercalatable metal oxides and/or Li intercalatable carbons (carbon black, graphite etc.) are added and dispersed and this dispersion is then applied onto current collectors (foils, strips, networks etc—Cu preferably for the anode, Al preferably for the cathode) depending on the film coating technique used.

One variation (1a) of the coating technique described above consists of using aqueous polymer dispersions instead of the polymer solution with organic solvents. The coatings obtained according to 1 or 1a are processed, after drying (wound) to form prismatic or wound cells, a so-called separator e.g. of Cellgard or such like with porous structures being used as intermediate layer, a system thus produced being placed into a housing and, before being closed, filled with (electrolyte) solution of supporting electrolyte (i.e. supporting electrolyte dissolved in aprotic solvents) (e.g. by applying a vacuum).

The Bellcore process (1b) is a variation of the coating technique; in this case, a component (dibutyl phthalate DBP, for example) was incorporated into the anode and/or cathode mass, which component was removed by dissolution before combining the anode/cathode/separator in the so-called Bellcore process (compare literature reference 2), in order to provide a satisfactory porosity, i.e. absorption capacity for the supporting electrolyte solution (electrolyte).

A process which is basically different (2) consists of the extrusion e.g. of the separator (polymer gel electrolyte) and e.g. a cathode (U.S. Pat. No. 4,818,643, EP 015 498B1) and/or the extrusion of the anode, separator and cathode in extruders connected in parallel with subsequent combining (DEO 10 020 031) coextrusion according to literature reference Polymeric (Materials and Processing edit., J. M. Charrier, Hanser Vertag Munich 1990 page 387/388). The processes described so far have all had disadvantages, though they may be different: during the coating processes (1-1a), the organic solvent and/or the water (entrained by the polymer solution and/or dispersion) needs to be eliminated in all cases. Remaining solvent leads to “fading” i.e. loss of efficiency of the battery and lack of cycle stability, the organic solvent needs to be removed for reasons of costs and environmental protection which means high drying temperatures or, in the case of the continuous process, longer drying times with lower drying temperatures and vacuum; the same applies to the removal of water: disadvantages arise in the film: in homogeneities, crack formation during tight winding, reduced adhesion on the current collectors, damage to the current collectors, migration of the electrolyte underneath the film etc.

Only unsatisfactory wetting of the anode mass and/or cathode mass occurs during filling with electrolyte.

In process 1b, the necessary porosity for absorbing the electrolyte is obtained; however, all the other disadvantages mentioned for 1-1a remain applicable also to 1b.

Polyethylene oxide (PEO) is one of the products used for (2), the extruder process (U.S. Pat. No. 4,818,643); however, this does not exhibit any long term stability, i.e. a cycle stability of <100, during battery operation. The other extruder process operates—compare examples with electrolytes based on EC/γ-BL (i.e. ethylene carbonate, γ-butyrolactone)—with LiClO4 as supporting electrolyte; this system, too, exhibits a low cycle stability of <100 since γ-BL reacts under the operating conditions of the battery and leads to the formation of interfering secondary products; the claimed polymer PMM (polymethylacrylate) is also unstable and leads to undesirable secondary reactions. The recipes for the anode, cathode and the separator (polymer gel electrolyte) mentioned in the examples and the process detailed in example (1) do not lead to an operational battery with the data disclosed.

The present invention avoids the disadvantages of the known processes by way of a new process concept with new components.
1. The extruder mass and separator are produced by liquid coating and liquid extrusion, i.e. the mass contains the electrolyte and the optimum supporting electrolyte concerned.
2. Before processing, i.e. liquid coating, liquid extrusion, the anode mass as well as the cathode mass are added to other feed materials, i.e.
a) dust portions with a particle size of <6 μm are sieved out
b) the materials are degassed under vacuum and consequently liberated of adsorbed air and oxygen
c) processing takes place under argon
d) the anode material, i.e. Li intercalatable carbons, are treated with Li n-butyl before use
e) by grinding, thorough mixing and wetting of the electrode mass with supporting electrolyte and electrolyte (aprotic solvent) takes place
   Active Components

For the anode (AM): Natural, ground, non-ground, modified graphite. Synthetic graphite, mesophases, micro-beads, graphene, polyphenylenes, polyacetylenes: all C materials capable of forming intercalates with Li.

For the cathode: Ni, Co, Cr, Mo, W, Mn, Ti, Zr oxide and similar heavy metal oxides capable of forming intercalates with Li.

After evacuation with supporting electrolyte, supporting electrolyte additives and/or solvents, the active components of the electrode mass are wetted and/or impregnated e.g. by intensive grinding or stirring, if necessary at elevated temperatures—preferably at up to 100° C. All work is carried out under argon.

The following are suitable supporting electrolytes: (compare literature reference 1—Introduction) LiPF₆, LiCF₃SO₃, Li[N(SO₂CF₃)₂], Li[C(SO₂CF₃)₃], LiOB (Li oxalatoborate) or other organo-Li-borates and such like. Supporting electrolyte additives are: organic salts of the above-mentioned supporting electrolytes in the case of which Li is replaced by an organic radical such as imidazolyl⁺, also Li acetyl acetonate, Li metaborate, Li silicates, including natural ones such as spodumene, petalite, lepidolite, cryolthionite as well as carbon fibres or carbon powder saturated with or encased in Li salts, as well as MgO, BaO, Al₂O₃ and such like such as layer silicates, e.g. serpentine and/or tectosilicates such as zeolites which act as acid scavengers, water adsorbers or depot for supporting electrolytes, solvents or electrolytes.

Solvents according to the invention (compare literature reference 1) are:

Caronates: diethyl carbonate, DEC, dimethyl carbonate, DMC, ethyl-methyl carbonate, EMC, ethylene carbonate, EC, propylene carbonate, PC and such like, e.g. methoxyethyl methyl carbonate.

Glycol ethers: dimethoxyethane, DME and homologues oxazolidinones: subst. ureas and fluoroethers (low molecular with molecular weights of up to 1500) and fluoroalkyl methacrylic acid esters and analogues such as: suitable fluorine derivates are unsaturated polymerisable compounds with the general formula CH₂═C(R₁)—COO—R₂
R₁═H, preferably CH₃
R₂=perfluoroalkyls or
e.g. heptafluorobutyl methacrylate (2,2,3,3,4,4,4)alkyl ether with C₂ to C₂₀
hexafluorobutyl methacrylate (2,2,3,4,4,4)
hexafluoroisopropyl methacrylate (1,1,1,3,3,3)
perfluoroctyl methacrylate
octafluoropentyl methacrylate (2,2,3,3,4,4,5,5)
perfluoroundecyl methacrylate
trifluoromethoxymethyl acrylate CH═C(CH₃)—COO CH₂CH₂—O—CF₃
also special monomers with ether radicals or carbonate radicals such as methoxymethyl methacrylate (CH₂═C(CH₃)—COO CH₂CH₂—O—CH₃) or e.g. diacrylate(methacrylates)
hexafluoro 1,5-pentane diyl dimethacrylate CH₂═C(CH₃)—COO CH₂(CF₂)₃ CH₂—OOC—C(CH₃)—CH₂ and/or monomers such as vinyl pyridene, vinyl pyrrolidone and such like.

Preparation of the active components of the electrolyte mass:

Processing takes place under exclusion of air (oxygen and nitrogen); argon is preferably used as blanketing gas.

Appropriately, the active components are degassed under vacuum at temperatures of 0-200° C., preferably at room temperature to 100° C., at pressures of 20 to 10⁻⁴ torr, preferably at 2 to 10⁻² torr, before they are contaminated with LS, LSA or LM.

The usual grinding or mixing tools are used for intensive mixing, though ultrasonic devices are also suitable. An essential feature is the manufacture of “batches” (literature: Ullmann's Encyclopedia of Industrial Chemistry, B. 2, 5-1 to 5-38, 7-1 to 7-36, 24-1, 25-1 to 25-31 to 27-16 (1988), VCH Weinheim).

Modifications of the Li intercalatable carbons with Li alkyls are a precondition for the use of these components. Details regarding the preparation of the active components of the electrode mass are provided in the examples.

Polymer Binders:

The polymer binders are networks (fabrics) or such like which should preferably be electrically conductive, contain supporting electrolytes, additives and solvents in the incorporated state or possess a jacketing of supporting electrolyte, additive, if necessary in combination with the solvent.

The polymer binders are polymers with molecular weights of 20,000 to 2 million, preferably of 30,000 to 500,000.

Polyolefins, polyethylene, polypropylene, polybutenes as well as their copolymers, preferably with olefins or acrylic acid esters/methacrylic acid esters with alkyl ester groups of C>3, also polyvinyl ether as well as polystyrene and copolymers with butadiene or isoprene, preferably block copolymers produced anionically, as well as rubber, e.g. butyl rubber and/or SB rubber or polydienes (manufactured with Ziegler-Natta catalysts: literature reference H. G. Elias Makromoleküle, volume 2, page 141 (1992) Verlag Hüttig and Wepf-Basle) as well as fluoroelastomers, preferably copolymers or terpolymers based on PVDF, HFP, TFE and/or perfluoroalkoxy derivatives (lit. Ullmann's Encyclopedia of Industrial Chemistry, volume A 11, page 402-427, Verlag VCH-Weinheim 1988) are suitable; in addition, polyethers made from ethylene oxide, propene oxide, butene oxide as homopolymer and/or copolymer with capped end groups are suitable, polyvinyl pyrrolidone and copolymers such as vinyl imidazol or methacrylic acid esters or vinyl caprolactam also deserve interest. According to the process of the invention, the above-mentioned polymer binders are employed as electrically conductive polymers in the Li battery system by mixing them e.g. with conductivity carbon black.

The production of the polymer binders according to the invention takes place by incorporation or jacketing. As an example, Styrolex® styrene-butadiene-styrene triple block polymer is filled with 30% by weight carbon fibres (literature: Ullmann's Encyclopedia of Industrial Chemistry volume A 11, page 42-64) and then coated with a coating consisting of (10% by weight) polyvinyl pyrrolidone (Luviskol) in 1 M LiOB/dimethoxyethane solution and used as matrix for the active anode mass and/or cathode mass; in an analogous manner, fluoroelastomers such as Kynar 280® and/or Dyneon THV 200® are used as PB; these are mixed e.g. with a solution of ECIPC 1:1 and LS:LiPF₆ (1M) with LSA:MgO and, if necessary, carbon fibres.

If intrinsically conductive polymers such as polyacetylene, polypyrrol, polyaniline or carbon fibres are used, these are preferably impregnated with supporting electrolyte+solvent (LiOB+DMC/DEC) and then used as a lattice, network or similar for fixing the electrode mass, if necessary, also in combination with the other polymer binders e.g. those mentioned above.

The separator is an intermediate layer, separates the anodes and the cathode as a film, mesh fabric, fleece, woven fabric and such like and is made or used either by liquid coating or extrusion.

The separator:
a) has a sufficiently high conductivity for the transportation of the ions of the supporting electrolyte components
b) is a supporting electrolyte and solvent depot
c) exhibits flexibility
d) serves as a melt safeguard against overloading
e) and exhibits no failure mechanisms during normal battery operation, defined charging and discharging.

The separator can be used as a separate intermediate layer but can also be an integrated part of the cathode and/or anode.

The separator consists of organic polymers (compare polymer binder PB) and, if necessary, supporting electrolyte, supporting electrolyte additives and/or solvents. For the use according to the invention, porous structures are preferred. The manufacture takes place by extrusion, casting, coating etc.

Conductors: They are used to discharge the current produced in the battery system (to the + or − pole of the battery); they should adhere tightly to the electrode mass and exhibit as low an electrical contact resistance as possible.

Suitable conductors are carbon fibres, graphite, electrically conductive polymers and/or metals; preferably, the cathode conductor is primer-coated, e.g. with carbon black/terpolymers Dyneon THV. An important aspect with conductors is the presence of an active, fat-free and coating-free surface onto which the primer and/or the active electrode mass can be applied. The primer layers are 0.1 to 10 μm thick. Primer layers are obtained by C-plasma coating, applying e.g. carbon black-filled polymers such as Kynar 2801 with 30% by weight of carbon black in NMP, polyacrylonitril with 30% by weight of carbon black in DMF, Dyneon THV® 30% by weight of carbon black, aqueous, polyvinyl alcohol+30% by weight of carbon black, aqueous (DMF=dimethyl formamide, NMP=N-methyl pyrrolidone).

The process according to the invention is based on the coating and/or extrusion technology in the case of which all the necessary components for the electrodes concerned and/or for the separator are present as spreadable, coatable or extrudable mixtures with solvents, supporting electrolyte, additives and the active components (Li intercalatable carbons and/or Li intercalatable heavy metal oxides) and processed in a continuous, preferably single stage process, with the monomers polymerising and solidifying. The mixtures consist of dispersions and/or spreadable pastes which are applied onto the primer-coated conductors at room temperature, e.g. primer-coated Cu foil—is coated with the anode mass (15-40 μm thick), then the cathode mass is applied with the separator (15-40 μm thick) and finally, the cathode conductor Al foil primer coated with Dyneon THV/carbon black) is applied. The composite system thus formed is laminated and wound, placed in a housing, poled etc. to form salable, rechargeable Li batteries.

The process of manufacture can also be designed such that a double-sided coating can be effected and/or parallel anode and/or cathode conductors can be coated and the separator is then integrated into the composite structure as isolating intermediate layer—as foil saturated with supporting electrolyte and solvent or as coating laminate.

An essential advantage of the process also consists of the use of small quantities of vermiculite which expands during laminating at elevated temperatures and thus provides additional porous structure conditions with improved migration conditions for the “electrical” transport processes.

### EXAMPLES

The anode masses contain:

| | | | |
|---|---|---|---|
| 50-85% by weight | Li intercalatable carbon + | | |
| | additive | | |
| 5-20% by weight | Polymer binder | {close oversize brace} | Solids |
| 0.1-5% by weight | Supporting electrolytes | | |
| 10-40% by weight | Organic solvent | | |

The separator (as gel electrolyte):

| | | | |
|---|---|---|---|
| 25-60% by weight | Polymer binder + | | |
| | additive | {close oversize brace} | Solids |
| 1-15% by weight | Supporting electrolytes | | |
| 35-65% by weight | Organic solvent | | |

The cathode masses contain:

| | | | |
|---|---|---|---|
| 50-85% by weight | Li intercalatable | | |
| | heavy metal oxides + | {close oversize brace} | Solids |
| | additive | | |
| 5-20% by weight | Polymer binder | | |
| 0.1-5% by weight | Supporting electrolytes | | |
| 10-50% by weight | Organic solvent | | |

Organic solvents are preferably aprotic solvents which are suitable for use as solvents for the supporting electrolytes but also as swelling agents for the polymer binder, as well as polymerisable monomers and/or fluorine-containing flame proofing agents. In the following, some of the coating masses according to the invention are described: the separator masses (included in the solids content) contain at least 1% by weight of vermiculite (in the unexpanded state).

All composites of anode, separator and cathode additionally contain in at least one component active substances containing unsaturated, cross-linkable, reactive double bonds.

Anode Mass AM I

| | | | | % by Weight |
|---|---|---|---|---|
| 1. | Polymer binder | | Kynar 2801 ® + divinyl | 4 + 1 |
| | | | benzene | |
| 2. | Polyether | | Polyox WSR 301 ®* | 3 |
| 3. | Graphite (synth) | | MCMB ® | 3 |
| 4. | Additive | | MgO vermiculite | 1 |
| | | | (non-expanded) | |
| 5. | Solvent | | ethylene carbonate EC | 5 |
| 6. | Graphite (nat) | | UF8 ® | 65 |
| 7. | Solvent: | a) | perfluoroethyl methacrylate | 2 |
| | | b) | diethyl carbonate DEC | 4 |
| | | c) | dimethyl carbonate DMC | 3 |
| 8. | Supporting | | Li triflate | 8 |
| | electrolyte | | | |

*The ether was capped with dimethyl sulphate before use, i.e. the —OH groups present were converted into —OCH3 end groups.

Components 1, 3 and 4 are intensively mixed (2 h) at room temperature and subsequently with 4,5,7a, 7b, 7c (room temperature 1 h).

In parallel, the graphite (6) is provided, supporting electrolyte (8) is added and grinding carried out for approximately 30 min at room temperature; subsequently, the capped polyether and the solvent (7c) are added in succession and stirring is continued for a further 1½ 2 h (room temperature). The graphites (3) and (6) used were degassed at 10⁻² torr and 100° C. before use and subsequently processed further under argon.

Anode Mass AM II

Instead of polyether (2), poly-n-hexyl methacrylate, molecular weight 30-50,000, is used. The work is carried out under argon, the graphites are heated under vacuum at 100° C. and 0.1 torr and subsequently reacted at room temperature with n-butyl lithium (5% in n-hexane) (10 ml n-BuLi solution per 100 g of graphite subsequently again reheated, degassed and processed as detailed above.

Anode Mass AM III

7% by weight of LiPF₆ and 1% by weight of MgO are used as supporting electrolyte.

Anode Mass AM IV

Li oxalatoborate LiOB, 8% by weight, is used as supporting electrolyte and vinyl pyrrolidone is used instead of divinyl benzene 1% by weight.

Anode Mass AM V

4% by weight of Dyneon THV are expanded with 1% by weight of hexafluoro-1,5-pentane diyldimethacrylate as polymer binder and 10% by weight of graphite (6) UP8® are added and thoroughly ground at 50° C. for 60 min. (argon blanketing atmosphere); subsequently, 5% by weight (2) of Polyox WSR 301® esterified with methacrylic acid groups at the terminal OH groups and 8% by weight of supporting electrolyte (8) LiPF₆ are added and ground once more for 60 min., subsequently, 60 parts of graphite (6) UP8® and the solvents (7a-7c)+(5) as well as the supporting electrolyte additive I % by weight of Li acetyl acetonate are added to the substance to be ground and grinding is again carried out for 60 min. at 50° C.

Subsequently, the ground substance is extruded from a Collin extruder at 65-70° C. through a slot die onto a primer-coated Cu foil: thickness 30-40 μm, and compacted to 25-30 μm by subsequent laminating.

All work is carried out under argon as blanketing gas, the graphites used were degassed before use at 100° C., 3 h at 0.1 torr and treated with Li-n-butyl in the same way as the anode mass AM II.

Anode Mass AM VI

In the same way as AM I used as solvent 7a (2% by weight) ethylene glycol dialkyl ether is used.

All the graphites used had an ash content (DIN 51903, 800° C.) <0.01% and contained no particles of <6 μm

Cathode mass KM I

| | | | | % by Weight |
|---|---|---|---|---|
| 1. | Li intercalate | | Co oxide | 70 |
| | metal oxide: | | | |
| 2. | Polymer binder | | Kynar 2801 ® | 6 |
| 3. | Polymer additive | | Luviskol ® | 1 |
| | | | | (molecular |
| | | | | weight 5-10,000) |
| 3. | a monomer | | ethylene glycol | 2 |
| | | | dimethacrylate | |
| 4. | Supporting | | Li oxalatoborate | 7 |
| | electrolyte | | | |
| 5. | Additive | | | — |
| 6. | Solvent: | a) | DME dimethoxyethane | 1 |
| | | b) | EC ethyl carbonate | 6 |
| | | c) | DEC diethyl carbonate | 4 |
| | | d) | DMC dimethyl carbonate | 2 |

The cathode mass KM I is produced by mixing LiCo oxide (1) with Li oxalatoborate; the mixture of polymer binder (2), polymer additive (3), monomer (3a) and solvents (6a-6d) is then added and mixed thoroughly for 2 h at room temperature.

Cathode Mass KM II

A mixture of LiNi oxide and LiCo oxide (weight 1:1) is used as Li intercalated metal oxide.

Cathode Mass KM III

Li(trifluoromethyl sulphonyl)imide Li[Ni(SO₂CF₃)₂is used as supporting electrolyte (4) and Al₂O₃ as supporting electrolyte additive.

Cathode Mass KM IV

Spinel Mn oxide is used as Li intercalated metal oxide (1) in a quantity of 65% by weight; 5% by weight of Ensaco carbon black is then added to the LiMn oxide and EC is added to the supporting electrolyte (4) and to the solvent (6b) and grinding carried out for 30 min. at room temperature in a ball mill; subsequently, the mixture of the remaining components of the batch: monomer (3a), polymer binder (2), polymer additive (3) and the solvents (6a, 6c, 6d) are added and mixing is carried out for 60 min. at room temperature (40V/min).

All heavy metal oxides were degassed, 10−1 torr, 1 h, 100° C., and processed under argon. Micro-particles of <6 μm were removed by sieving.

Separator Masses

These are layers between the anode and cathode and consist of polymers with a porous structure which are present in the form of woven fabrics, fleece, networks, perforated foils or such like and have a thickness of 10-30 μm, preferably 5-20 μm. The materials can be of an organic or inorganic nature, if necessary they are mixtures; a suitable form of the separator consists of sol-gel coatings or coatings applied onto the anode mass and/or cathode mass—or on both—and then form the separator layer between the anode and cathode during the joining operation.

A preferred form of the separator consists of extruded foils in the thicknesses indicated which can be made in the form of anode and/or cathode mass also by extrusion and then combined to composite systems by coextrusion in line with the arrangement shown in FIG. 2a/2b (literature reference L. M. Carrier: Polymeric materials and processing, Hanser Verlag Munich (1990) page 387).

The literature reference detailed above shows arrangements for coextrusion and joining of the individual extrudates to form a uniform composite system.

In the case of the extruded separators, polymers, e.g. fluoroelastomers based on tetrafluoroethylene, hexofluoropropene and vinylidene fluoride as Bi or terpolymer, e.g. Kynar 2801® Dyneon THV 120® or such like, polyvinyl pyrrolidone, polyether and such like, polymers expanded with the solvents based on alkyl carbonates or low molecular glycol ethers or polyfluoroethers are used.

The proportion of polymers is 5-20% by weight, that of the solvent 10-50% by weight, based on the total weight of the separator respectively.

The compounds listed under the anode and cathode masses are suitable for use as supporting electrolytes which are used in quantities of 1-15% by weight.

The preferred supporting electrolyte additives are MgO, Al₂O₃, SiO₂ and builders such as kaolins, zeolites, serpentines and vermiculite in the expanded and unexpanded state.

Separator

For the production of the separator mass, ethylene carbonate and propylene carbonate are added to polymers, e.g. Kynar 2801®+polyvinyl pyrrolidone (molecular weight 5,000) and mixed in a Voith mixer at 100° C., for 60 min. under argon blanketing gas; subsequently, cooling to room temperature is carried out and the mixture is granulated; these granules are then introduced into a Collin extruder (filling nozzle 1) and extruded at a temperature of 85-90° C.; simultaneously, a mixer of diethyl carbonate/LiPF₆/MgO and vermiculite (unexpanded) is metered into the second filling nozzle of the extruder with stirring and the mixture, following residence times of approximately 2 minutes, discharged through a slot die, 15 cm wide, in the form of a film 30-35 μm thick and joined in a laminator as intermediate layer between the cathode and anode, which are provided with conductor foil, and compacted to form a composite system.

All separator masses contain Si—S VII 1% by weight vermiculite (unexpanded).

### Example 1

The anode mass AM II was applied directly onto a Cu foil (8 μm thick) under blanketing gas (Ar) in a Collin extruder at temperatures of 40-45° C. via a slot die 150 mm wide, in a thickness of 15-20 μm and laminated at 80° C. The system of Cu conductor with anode mass thus obtained was combined, in a further step, with a separator S I and the cathode mass KM I applied onto primer-coated Al to form a composite battery system and laminated at 80° C.

### Example 2

The cathode mass KM I is extruded (in the same way as anode mass AM I in example 1) under argon as blanketing gas in a Collin extruder at 100-105° C. (width 150 mm and thickness 10-25 μm) and laminated directly after discharge from the slot die onto a primer-coated Al foil (thickness: 12 μm, primer layer 3 μm) and combined with a separator film (Solupren) impregnated with a 1M solution of LiPF₆ in monoglycol-bis-tetrafluoroethyl ether (HC₂F₄—O—CH₂—CH₂—C₂F₄H) and then continuously laminated with the anode mass AM II applied onto a primer-coated Cu foil.

### Example 3

The composite system produced correspondingly (example 1-example 2) is processed into a coil, placed in a housing and processed into a battery ready for use by laser welding of the electrolyte conductors to the + or − poles. The diameter of the battery is 8 cm, charging takes placed galvanostatically (Digatron charger), first stage to approximately 3 volt, then up to 3.5 and finally up to 4.1 volt, at 0.15 mA/cm² respectively.

Discharging takes place at 0.15 mA/cm². The discharge capacity is 43 Ah with an active surface of 0.5 m².

The cycle stability is >300, fading approximately 1%.

If, instead of S I, Solopur® or Cellgard® are used as separator, equally good results are obtained.

TABLE 1

| | Example | | | | | |
|---|---|---|---|---|---|---|
| | 4 | 5 | 6 | 7 | 8 | 9 |
| Anode mass AM | I | II | III | IV | V | I |
| Cathode mass KM | I | II | III | IV | I | I |
| Separator S | I | III | IV | V | VI | VI |
| Discharge capacity | 43 | 42 | 44 | 42 | 42 | 42 |
| (Ah) | | | | | | |
| Cycle stability | >300 | >300 | >300 | >300 | >300 | >350 |
| Fading | ˜1% | ˜1% | <1% | ˜1-2% | <1% | <2% |

Processing takes place as for Examples 1-3, as separator was used, details in ( ) are parts by weight.

| | | | | | |
|---|---|---|---|---|---|
| S 1 | Kynar 2801 (30) | Polymethyl-methacrylate (5) | MgO (9) | 0.5 LiOB in EC/PC | (55) |
| S II | Kynar 2801 (30) | Styroflex (2) | MgO (3) | 1 M LiPF₆ in EC/DC | (64) |
| S III | Dyneon THV 200 (32) | | MgO (7) | 1 M LiPF₆ in EC/DC | (60) |
| S IV | Polypropylene (20) | Polyvinyl pyrrolidone (10) | MgO (9) | 1 M LiPF₆ in EC/DC | (60) |
| S V | Kynar 2801 (30) | Styroflex (2) | Li acaco (7) | 0.5 M LiOB in DME | (60) |
| S VI | Kynar 2801 (30) | A1203 (5) | LiOB (4) | 1 M Litriflat in EC/DC | (60) |
| S VII | Kynar 2801 (30) | Styrolex (5) | MgO (4) | 1 M LiPF₆ in EC/DC | (60) |

EC/PC volume 1:1,
EC/DC volume 1:1

### Comparative Examples

If work is not carried out under the conditions according to the invention, i.e.
1. Degassing of the active masses
2. Intensive mixing of the starting products under blanketing gas (argon)
3. Separate two-stage mixing of the active components, cycle stabilities of only 50-150 are achieved with a fading of >2.5%.

1-27. (canceled)

28. A process for the manufacture of a storage device for electrical energy, the process comprising:
degassing an anode mass, the anode mass comprising a lithium intercalatable carbon in a mixture comprising one or more of an organic solvent, a supporting electrolyte, a polymer binder and a supporting electrolyte additive;
degassing a cathode mass, the cathode mass comprising a lithium intercalatable heavy metal oxide in a mixture comprising one or more of an organic solvent, a supporting electrolyte, a polymer binder and a supporting electrolyte additive;
applying the anode mass to a current conductor and applying the cathode mass to a current conductor;
disposing a separator between the anode mass and the cathode mass to form a composite;
and
laminating the composite to form the storage device.

29. The process according to claim 28 wherein the anode mass and the cathode mass are degassed at temperatures from −20° C. to 200° C.

30. The process according to claim 29 wherein the anode mass and the cathode mass are degassed at temperatures from 20° C. to 150° C.

31. The process according to claim 29 wherein the anode mass and the cathode mass are degassed at pressures from 20 torr to 1×10⁻⁴ torr.

32. The process according to claim 28 wherein the process is carried out under a blanketing gas.

33. The process according to claim 32 wherein the blanketing gas comprises argon.

34. The process according to claim 28 wherein the process is carried out in the presence of perfluoroalkyl ethers.

35. The process according to claim 28 wherein the Li intercalatable carbon of the anode mass comprises graphite.

36. The process according to claim 35 wherein the graphite has a globular structure.

37. The process according to claim 28 wherein the Li intercalatable carbon is selected from the group consisting of graphenes, polyphenylenes, and polyacetylenes.

38. The process according to claim 28 wherein the Li intercalatable carbon comprises nano-dimension carbon fibres having a hollow, porous structure.

39. The process according to claim 28 wherein the Li intercalatable carbon comprises from 50 to 85% by weight of the anode mass.

40. The process according to claim 28 wherein the Li intercalatable heavy metal oxide is selected from the group consisting of Ti, Zr, V, Cr, Mo, W, Mn, Co, and Ni oxides.

41. The process according to claim 40 wherein the Li intercalatable heavy metal oxide is in an oriented form with a distorted lattice structure.

42. The process according to claim 40 wherein the Li intercalatable heavy metal oxide comprises from 50 to 85% by weight of the cathode mass.

43. The process according to claim 28 wherein the supporting electrolyte comprises one or more of Li organoborates, LiBF4, LiClO4, LiPF6, Li triflate, Li trifluoromethyl sulphonylimide, Li trifluoromethyl sulphonylmethide, and Li trifluoromethyl sulphonyl bismethide.

44. The process according to claim 43 wherein the supporting electrolyte comprises from 0.1% to 15% by weight of the anode mass or the cathode mass.

45. The process according to claim 28 wherein the additive comprises one or more of Li acetyl acetonate, Li metaborate, Li silicate and spodumene.

46. The process according to claim 28 wherein the additive comprises one or more of vermiculite, MgO, BaO, Al2O3, and SiO2.

47. The process according to claim 28 wherein the additive is impregnated with a Li salt.

48. The process according to claim 28 wherein the additive comprises from 0.1 to 30% by weight of the supporting electrolyte.

49. The process according to claim 28 wherein the organic solvent dissolves the supporting electrolyte, dissolves the additive and expands the polymer binder.

50. The process according to claim 49 wherein the organic solvent is a carbonate selected from the group consisting of an alkyl carbonate, a dimethyl carbonate, diethyl carbonate, ethylmethyl carbonate, ethylene carbonate, propylene carbonate, and methoxyethyl methyl carbonate.

51. The process according to claim 49 wherein the organic solvent is selected from the group consisting of a glycol ether, a substituted urea, a cyclic urea, and a fluoroalkyl methacrylic acid ester.

52. The process according to claim 49 wherein the organic solvent comprises from 1 to 1000% by weight of the supporting electrolyte.

53. The process according to claim 28 wherein the polymer binder comprises one or more of polyolefins, polyethylene, polypyrrolidone, polybutenes, and homologues and copolymers thereof.

54. The process according to claim 53 wherein the polymer binder comprises 5 to 30% by weight of the anode mass or the cathode mass.

55. The process according to claim 28 wherein the separator comprises one or more of a film, a foil, a netting, a woven fabric and a fleece.

56. The process according to claim 28 wherein when the separator comprises organic polymers and one or more of a supporting electrolyte, an additive and an organic solvent.

57. The process according to claim 28 wherein the process further comprises:
mixing and grinding the organic solvent, the supporting electrolyte, and the additive to form a mixed substance in the cathode mass and the anode mass, and
compounding the mixed substance with the lithium intercalatable carbon of the anode mass and the lithium intercalatable heavy metal oxide of the cathode mass.

58. The process according to claim 57 wherein the mixing and grinding occurs in an ultrasonic bed.

59. The process according to claim 57 wherein the mixing and grinding occurs at temperatures of −20 to 200° C.

60. The process according to claim 57 wherein the mixing and grinding occurs at temperatures of room temperature to 100° C.

61. The process according to claim 28, wherein
the anode mass comprises a spreadable, coatable and extrudable mixture of the solvent, the supporting electrolyte, the additive, the polymer binder, and the lithium intercalatable carbon;
the cathode mass comprises a spreadable, coatable and extrudable mixture of the solvent, the supporting electrolyte, the additive, the polymer binder, and the lithium intercalatable metal oxide; and
the separator comprises a spreadable, coatable and extrudable mixture of a solvent, a supporting electrolyte, an additive, and an organic polymer;
wherein the steps of manufacturing the storage device are performed in a continuous, single stage manner.

62. The process according to claim 61 wherein the conductor comprises one or more of a metal foil, a carbon fibre fabric, a netting, a polyacetylene film, and a polypyrrolidone film.

63. The process according to claim 62 wherein the anode mass or the cathode mass is applied to the current conductor by a doctor blade application, coating and extrusion.

64. The process according to claim 61 wherein the cathode mass is applied to a current conductor comprising a primer-coated Al foil.

65. The process according to claim 61, wherein the anode mass or the cathode mass is applied to two sides of the current collector.

66. The process according to claim 28, wherein the composite is laminated at temperatures ranging from room temperature to 100° C.

67. A process for producing a lithium battery, the process comprising:
providing a storage device formed according to the process of claim 28, and housing and poling the storage device to form the lithium battery.

68. The process according to claim 28 wherein the polymer binder comprises one or more of polyvinyl ethers, polystyrene, polystyrene and butadiene copolymers, and polystyrene and isoprene copolymers.

69. The process according to claim 68 wherein the polymer binder comprises anionically produced block polymers.

70. The process according to claim 28 wherein the polymer binder comprises one or more of SBR rubber, butyl rubber, and cis-polybutadiene, and 1,2 polybutadiene.

71. The process according to claim 28 wherein the polymer binder comprises fluoroelastomers.

72. The process according to claim 71 wherein the polymer binder comprises one or more of fluoroelastomer copolymers based on vinylidene fluoride, hexafluoropropene, tetrafluoroethene, perfluoroalkoxy, and fluoroelastomer terpolymers based on vinylidene fluoride, hexafluoropropene, tetrafluoroethene, perfluoroalkoxy.

73. The process according to claim 28 wherein the polymer binder comprises polyalkylene oxides.
